(19) United States
(12) Patent Application Publication
(10) Pub. No.: US 2015/0261190 A1
(43) Pub. Date: Sep. 17, 2015

(54) TIMEPIECE

(71) Applicant: CREATIONS HORLOGERES DE LULLY SA, Lully (CH)

(72) Inventors: Anouk Danthe, Denens (CH); Olivier Leu, Denens (CH)

(73) Assignee: CREATIONS HORLOGERES DE LULLY SA, LULLY (CH)

(21) Appl. No.: 14/439,654

(22) PCT Filed: Oct. 30, 2012
(86) PCT No.: PCT/EP2012/071505

§ 371 Date: Apr. 29, 2015

(51) Int. Cl. G04B 37/00

(52) U.S. Cl. CPC G04B 37/00

(57) ABSTRACT

The invention relates to a timepiece comprising: a casing (10) with a bottom (12), a middle (14) and a control body (16) mounted movably in relation to the middle (14), a movement (18) housed in the casing (14), a glass (26) closing the casing, a dial (28) arranged between the movement (18) and the glass (26), said dial (28) comprising two polarised lenses (28a, 28b), at least one of which is mounted on a mobile frame (30), such that said polarised lenses (28a, 28b) can assume a first state wherein elements arranged behind the dial (28) in relation to the glass (26) are visible from the side of the glass (26) and a second state wherein said elements are hidden. A kinematic connection is arranged between the control body (16) and the mobile frame (30), said kinematic connection comprising a first toothing secured to the control body, a second toothing secured to the mobile frame and arranged in a different plane from that of the first toothing, and a setting-wheel train kinematically connecting the first toothing and the second toothing. The setting-wheel train is pivoted on the middle (14) and comprises at least two moving parts arranged in the same plane parallel to the plane defined by the movement (18), and at least two moving parts that are interconnected by a shaft pivoted on the middle (14) and orthogonal thereto.

### TECHNICAL FIELD

The present invention relates to the horology field. It more particularly relates to a timepiece comprising:
a box,
a movement housed in the box,
a glass closing the box,
a dial positioned between the movement and the glass.

This dial comprises two polarized lenses, at least one of which is mounted on a movable frame, such that said polarized lenses can occupy a first state in which elements situated behind the dial in reference to the glass are visible from the side of the glass, and a second state in which said elements are hidden.

### BACKGROUND OF THE INVENTION

The applicant is already the holder of patent EP 2185979, wherein a timepiece is described as defined in the preamble above. The embodiment primarily described proposes implementing a cover associated with the box. When the cover is closed, the two polarized lenses forming the dial do not allow light to pass and only the hands, for example to indicate the current time, are visible on a black background formed by the dial. When the cover is open, the two polarized lenses allow at least part of the light to pass such that the particular indications displayed behind the dial or any openings allowing the movement to appear are visible through the dial.

In the aforementioned document, the cover is kinematically connected to the polarized lenses, by means of a differential providing appropriate reduction and making it possible to control the positions occupied by the polarized lenses, when the cover is open or closed, respectively.

This document also proposes to act on the polarized lenses, by means of a rotating bezel, but without precisely describing how the rotating bezel is connected to the differential input. It is also proposed to connect the cover and the polarized lenses, using an intermediate wheel train, for example to actuate a small polarized lens positioned on a sub-dial.

The implementation of a differential in the device described in document EP 2185979 has the advantage of making it possible to obtain a significant reduction ratio in a reduced space. However, its implementation is complex and the watch box incorporating that differential alone is a true horological complication.

With the aim of obtaining a simpler box construction, it is in fact possible to eliminate the differential and eliminate the cover, by actuating the polarized lenses via a rotating bezel. However, the implementation of such a solution does not go without saying. Indeed, the immediate solution may come to mind would be directly securing the rotating bezel and one of the polarized lenses, but this presents sealing problems. Furthermore, if one wishes to create a kinematic link between such a rotating bezel and at least one of the polarized lenses when those lenses have dimensions that make it possible to cover the entire dial, spatial constraints arise that are particularly delicate if one wishes to make the kinematic connection invisible.

The present invention aims to resolve the aforementioned problems by offering an implementation of a timepiece provided with a dial in the form of two polarized lenses, that is simpler, without prejudice to the reliability and quality of the construction, in particular of the watch box.

### BRIEF DESCRIPTION OF THE INVENTION

More specifically, the invention relates to a timepiece as defined in the first paragraph above, wherein the box comprises a bottom, a middle and a rotating bezel mounted movably in reference to the middle. According to the invention, it comprises a kinematic link between the rotating bezel and the movable frame.

The kinematic link comprises:
a first toothing secured to the bezel,
a second toothing secured to the movable frame situated in a different plane from that of the first toothing, and
an intermediate wheel train kinematically connecting the first toothing and the second toothing, said intermediate wheel train being mounted on the middle and comprising at least two mobiles situated in a same plane parallel to the plane of the movement and at least two mobiles connected to each other by an arbor pivoted on the middle and orthogonal thereto.

### BRIEF DESCRIPTION OF THE DRAWINGS

Other details of the invention will appear more clearly upon reading the following description, done in reference to the appended figures.

FIG. 1 shows a cross-section of a timepiece according to the invention.

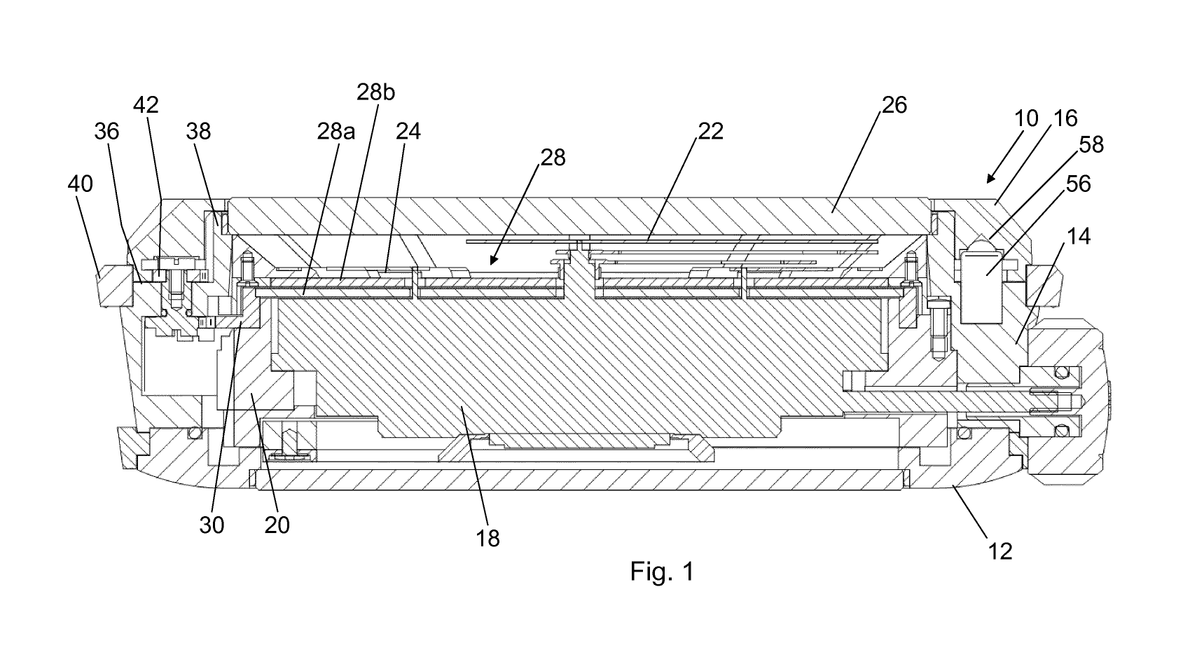

FIG. 2 shows a detail of the construction according to the invention.

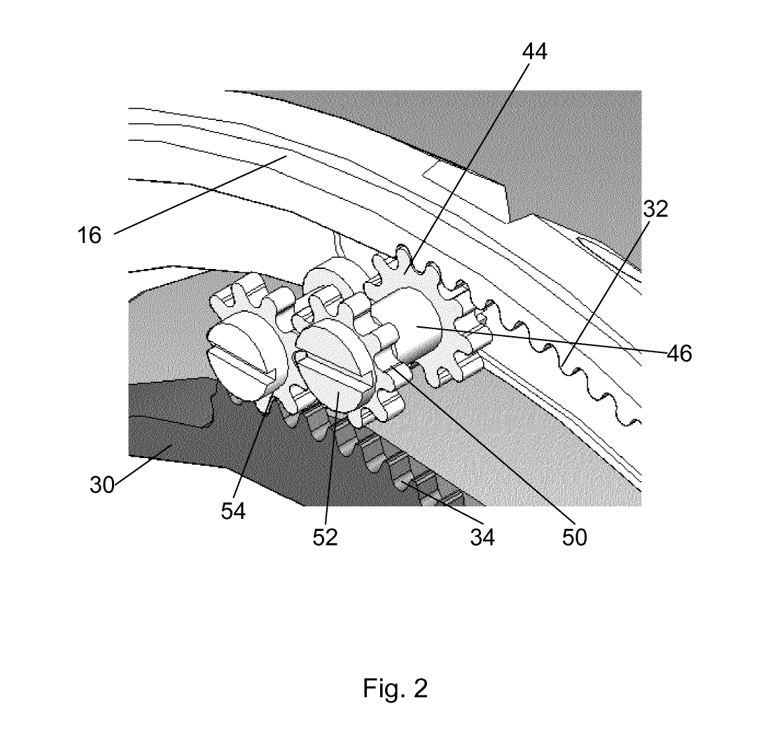

### DETAILED DESCRIPTION OF THE INVENTION

The figures show a timepiece according to the invention. It comprises a box 10 comprising a bottom 12, a middle 14 and a rotating bezel 16 mounted movably in reference to the middle 14. The bottom 12 can be at least partially transparent. The aspects of the construction of the box that are not part of the present invention will not be described in detail.

A movement 18 is mounted in the box, typically by means of a fitting circle 20. In the example, the movement is of the chronograph type. It makes it possible to display a current time using main display organs 22. It also makes it possible to display a time timed by secondary display organs 24. In the example, the timepiece comprises three off-centered sub-dials each associated with a small hand, to display information relative to the timed time, optionally a small second hand or for other information relative to the current time. The notion of “small hand” is known by one skilled in the art, and the term “small” will not pose any clarity problems.

As conventionally used, a glass 26 closes the box. A dial 28 is positioned between the movement 18 and the glass 26. The dial 28 comprises two polarized lenses 28a and 28b, at least one of which 28a is mounted on a movable frame 30, such that the polarized lenses 28a, 28b can be in a first state in which elements situated behind the dial 28 in reference to the glass 26 are visible from the dial side, and a second state in which said elements are hidden. The movable frame 30 is mounted pivoting around an axis situated at the center of the movement 18. According to the example, only one of the polarized lenses is movable, and the other is stationary.

In the illustrated example, the display organs are positioned between the dial 28 and the glass 26, such that they are still visible to user, either on a background 12 of the movement 18 when the polarized lenses 28a, 28b are in the first state, or on the background 12 of the dial 28 when the polarized lenses 28a, 28b are in their second state. The display organs that are pivoted at the center of the movement 18 are assembled on tubes that pass through the dial 28 at the center of rotation of the moving dial 30, such that a simple passage with a substantially circular shape arranged through the dial 28 makes it possible to perform the movements of the movable frame 30 and the polarized lens that it supports.

The display organs that are pivoted in off-centered sub-dials are assembled on tubes that cross through the center of the sub-dials. Although a single opening with a substantially circular shape, arranged in the stationary polarized lens in the center of the sub-dial, is sufficient, however, it is necessary to provide for arranging an opening with an arc of circle shape, centered on the center of rotation of the movable frame 30, in the polarized lens supported by the movable frame 30, to allow the passage of the tubes during movements of the movable frame 30.

For the movement of the movable frame 30, and therefore of one 28a of the polarized lenses, according to the invention, a kinematic link is provided between the rotating bezel 16 and the movable frame 30. Advantageously, that kinematic link comprises a first toothing 32 secured to the bezel. The first toothing 32 can be machined in the bezel or attached on the latter. The toothing can be oriented toward the inside or outside of the timepiece. The movable frame 30 is also provided with a second toothing 34.

The kinematic link also comprises an intermediate wheel train mounted pivoting on the middle 14, designed to kinematically connect the first toothing 32 and the second toothing 34. As can be seen in the drawings, the middle 14 is configured so as to have a seat 36 arranged parallel to the plane defined by the movement 18. That seat 36 extends by a flange 38, on which the glass 26 is in particular fixed. Furthermore, the bezel is mounted pivoting on the middle 14, while being guided by the seat 36 and the flange 38, and extends until it covers the flange 38. Lastly, a shank 40 is positioned at the periphery of the box, at the interface between the middle 14 and the bezel.

A housing 42 is arranged in the bezel, at the interface with the seat 36 across from it. The intermediate wheel train is advantageously mounted on the seat 36, in the housing 42.

More particularly, the intermediate wheel train comprises a first mobile 44 engaged with the first toothing 32. This first mobile 44 is mounted on a shaft 46 that crosses through the seat 36 orthogonally and is pivoted thereon. A sealing system, such as a seal, is intercalated between the arbor 46 and the middle 14. The intermediate wheel train also comprises a second mobile 50 assembled on the arbor 46, on either side of the seat 36. The assembly may be done, according to the proposed example, by a flat screw 52, which makes it possible to grip the second mobile 50 between the screw head and a rim of the arbor 46.

The intermediate wheel train also comprises a third mobile 54, situated in a same plane as the second mobile 50, the plane being parallel to the plane defined by the movement 18. The third mobile 54 is engaged with the second mobile 50 with the second toothing 34. The third mobile 54 is also pivoted on the middle 14. It may be connected to a second arbor 48 which, parallel to the first, passes through the seat 36 of the middle 14.

Thus, positioning an intermediate wheel train mounted on the middle 14 and comprising at least two mobiles (50 and 54) situated in a same plane parallel to the plane of the movement 18 and at least two mobiles (44 and 50) connected to each other by an arbor 46 pivoted on the middle 14 and orthogonal thereto, makes it possible to adapt the diameter of the mobiles to the spatial constraints of the box 10, in particular by positioning a mobile with a small diameter at the first toothing 32, where the available space between the bezel and the middle 14 is very limited. It is further possible to introduce a reduction ratio between the second 50 and third 54 mobiles, in order to improve the ergonomics of the actuation of the polarized lenses 28a, 28b, i.e., by adjusting the angle of rotation of the bezel necessary for the passage of the polarized lenses 28a, 28b from one state to another.

Implementing such a kinematic link may also allow an easy adjustment of the number of mobiles situated in a same plane, to produce the meshing with the second toothing 34, in any position, based on the specific constraints of a construction, in particular to specifically actuate a moving mobile associated with a particular sub-dial or a particular zone of the dial.

It is also possible to provide for driving several movable frames, each bearing a polarized lens, from a suitable kinematic link. Preferably, each of these movable frames is associated with a particular zone of the dial, for example at one or the other of the sub-dials. On that basis, it is possible to provide for actuating the different movable frames in a coordinated and synchronized manner, simultaneously or sequentially.

From the embodiment described above, it is also possible to provide for positioning each of the two polarized lenses 28a, 28b on a movable frame 30 and driving both of them using the rotating bezel, using the first and second kinematic links, as mentioned above. It is thus for example possible, by ensuring rotation of each of the frames in two opposite directions, to have a state change through a limited rotation of the bezel. It is possible to have the first mobile shared by the two kinematic chains and to mount two mobiles at different levels on the arbor, one being part of the first kinematic link and the other being part of the second kinematic link.

With this kinematic link, it is even possible to consider coupling the actuation of the polarized lenses 28a, 28b with another function also performed via the bezel, interacting with the movement 18, in particular a function of adjustment of the display.

Between the rotating bezel 16 and the middle 14, more particularly the seat 36, it is also possible to provide for producing a notching, typically using one or more ball-clicks 56, secured to the rotating bezel 16 or the seat 36. The ball of the click(s) may cooperate with a recess 58 arranged in the seat 36 or in the rotating bezel 16, respectively. Advantageously, the notching is engaged when the polarized lenses 28a, 28b are in their first and second states, respectively, and only in those states, in order to clearly indicate to the user that the rotating bezel 16 is in the position that corresponds to those states. According to the example, the notching is engaged when the ball clicks in the recess. In the case of alternatives with several movable frames actuated sequentially, the successive actuation positions of the different frames may be indicated by several notched positions.

In order to prevent the movable frame 30 from being driven over a first and second extreme position, receptively corresponding to the first and second states of the polarized lenses 28a, 28b, those extreme positions may be defined by bankings produced between the movable frame 30 and a reference element, for example the middle 14. In order not to damage the device if force is exerted on the banking, one skilled in the art may introduce a disconnecting gear, by friction/indenting in the intermediate wheel train, typically at one of mobiles mounted on the first arbor 46. Alternatively, the disconnection may be obtained by having toothings with a limited length, such that it is not possible to drive the frame past those extreme positions. A spring system will be provided, ideally arranged on the bankings, to avoid lag time or blockage, when actuation occurs in the opposite direction of the movable frame 30. More specifically, it is possible to have a banking able to be moved slightly in case of pressing, the movement of the banking driving stressing of a spring able to push back the banking. It is also possible to have an elastic zone on the banking, either by producing a flexible and elastic banking or by inserting a spring organ between the banking and the element (movable frame 30 or bezel) that abuts on it.

In one additional alternative that is not shown, it is also possible to provide for replacing the rotating bezel 16 with another control organ that would be kinematically connected to one of the polarized lenses, like what was described above, for example via a movable frame. Advantageously, it is thus possible to provide that the control organ is made in the form of a slide-bar mounted movably in reference to the box, that slide-bar being associated with a rack that meshes with the first mobile of an intermediate wheel train. The slide-bar may be mounted translatably or rotatably, typically at the periphery of the box. In the case of translational movement of the slide-bar, it will then be possible to connect it kinematically to a flexible polarized lens arranged so as to be moved between a first position, in which it forms the first state of the dial superimposed with the other polarized lens, and a second position, in which it forms the second state of the dial and does not appear superimposed with the other polarized lens. It can then be wound in a housing of the box or retracted on the other side of the movement. The control organ then advantageously drives a roller around which the flexible polarized lens can be placed. A curtain effect is thus obtained that moves in translation to “open” or “close” on the dial.

1-15. (canceled)

16. A timepiece comprising:
a box comprising a bottom, a middle and a control organ mounted movably relative to the middle,
a movement housed in the box,
a glass closing the box,
a dial positioned between the movement and the glass,
a kinematic link between the control organ and the movable frame, said kinematic link comprises a first toothing secured to the control organ,
a second toothing secured to the movable frame situated in a plane different from that of the first toothing, and
an intermediate wheel train kinematically connecting the first toothing and the second toothing, said intermediate wheel train being pivoted on the middle and comprising at least two mobiles situated in a same plane parallel to the plane defined by the movement and at least two mobiles connected to each other by an arbor pivoted on the middle and orthogonal thereto.

17. The timepiece of claim 16, wherein said dial comprises two polarized lenses, at least one of which is mounted on a movable frame, such that said polarized lenses can occupy a first state in which elements situated behind the dial in reference to the glass are visible from the side of the glass, and a second state in which said elements are hidden.

18. The timepiece of claim 16, wherein said intermediate wheel train comprises a first mobile engaged with the first toothing, said first mobile being mounted on an arbor that crosses through the middle orthogonally and is pivoted thereon, and
wherein said intermediate wheel train also comprises a second mobile assembled on the arbor, on the other side of the middle.

19. The timepiece of claim 17, wherein said intermediate wheel train comprises a first mobile engaged with the first toothing, said first mobile being mounted on an arbor that crosses through the middle orthogonally and is pivoted thereon, and
wherein said intermediate wheel train also comprises a second mobile assembled on the arbor, on the other side of the middle.

20. The timepiece of claim 18, wherein said intermediate wheel train also comprises a third mobile, situated in a same plane as the second mobile, the plane being parallel to the plane defined by the movement, and wherein said third mobile is engaged with the second mobile.

21. The timepiece of claim 19, wherein said intermediate wheel train also comprises a third mobile, situated in a same plane as the second mobile, the plane being parallel to the plane defined by the movement, and wherein said third mobile is engaged with the second mobile.

22. The timepiece of claim 20, wherein said third mobile is also engaged with said second toothing.

23. The timepiece of claim 21, wherein said third mobile is also engaged with said second toothing.

24. The timepiece according to one of claims 19 to 23, wherein the third mobile is connected to a second arbor which, parallel to the first, crosses through the middle.

25. The timepiece according to one of the claims 16 to 23, wherein the middle has a seat arranged parallel to the plane defined by the movement.

26. The timepiece according to one of the claims 16 to 23, wherein said control organ is a rotating bezel.

27. The timepiece according to claim 25 comprising a housing arranged in the rotating bezel, at the interface with the seat and across from it, said intermediate wheel train being advantageously mounted on the seat, in the housing.

28. The timepiece according to claim 26 comprising a housing arranged in the rotating bezel, at the interface with the seat and across from it, said intermediate wheel train being advantageously mounted on the seat, in the housing.

29. The timepiece according to claim 26, comprising a notching between the rotating bezel and the middle, said notching defining an engagement when the polarized lenses are in their first and second states, respectively.

30. The timepiece according to claim 27, comprising a notching between the rotating bezel and the middle, said notching defining an engagement when the polarized lenses are in their first and second states, respectively.

31. The timepiece according to one of claims 16 to 23, wherein the positions of the movable frame corresponding to the first and second states are defined by banking and wherein said kinematic link comprises a disconnecting gear.

32. The timepiece according to one of claims 16 to 23, wherein each of the polarized lenses is mounted on a movable frame and said timepiece comprising, aside from said kinematic link for driving said movable frame, a second kinematic link arranged to kinematically connect said control organ and a second movable frame.

33. The timepiece according to one of claims 16 to 23, wherein said dial covers the entire movement visible through the glass.

34. The timepiece according to one of claims 16 to 23, wherein said dial is a sub-dial that is off-centered relative to the center of the movement.

35. The timepiece according to one of claims 16 to 23, wherein said kinematic link may be connected to the movement to perform an additional function, in particular an adjustment function.

36. A timepiece comprising:
a box comprising a bottom, a middle and a control organ mounted movably relative to the middle,
a movement housed in the box,
a glass closing the box,
a dial positioned between the movement and the glass, said dial comprising two polarized lenses, at least one of which is mounted on a movable frame, such that said polarized lenses can occupy a first state in which elements situated behind the dial in reference to the glass are visible from the side of the glass, and a second state in which said elements are hidden,
wherein the moving polarized lens is flexible and is arranged so as to be moved linearly.
